(19) United States
(12) Patent Application Publication
(10) Pub. No.: US 2009/0194533 A1
(43) Pub. Date: Aug. 6, 2009

(54) CLOSURE WITH ADDITIVE RESERVOIR

(76) Inventors: Eric K. Lizerbram, Carlsbad, CA (US); Gerry R. Krippner, Oceanside, CA (US); Todd G. Buchholz, Solana Beach, CA (US); William S. Anapoell, San Diego, CA (US)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/025,345

(22) Filed: Feb. 4, 2008

(51) Int. Cl. B65D 51/00; B67D 5/00; B67D 5/40; B65D 25/40; B67B 5/00

(52) U.S. Cl. 220/212; 222/80; 222/386; 222/566; 222/153.13

(57) ABSTRACT

A closure with an additive reservoir is mounted on a container for a consumable liquid such as a beverage liquid or health drink. The closure has three components; a base, which includes the additive reservoir; a spout mounted on the base, and a plunger received in the additive reservoir. Upon depressing the plunger, an additive in the reservoir is released into the consumable liquid and upon moving the spout from a first position on the base to a second position on the base, a passageway through the base is opened so that the consumable liquid can flow to the consumer. Preferably, the additive chamber is mounted in the support column of the base with the passageway disposed between the additive chamber and the support column.

### FIELD OF THE INVENTION

The present invention is directed to a closure with an additive reservoir. More particularly, the present invention is directed to a closure with an additive reservoir wherein the closure is used to close a container containing a consumable liquid, such as but not limited to, a consumable liquid, and wherein the reservoir is opened to the container prior to using or consuming the liquid to allow the additive to mix with and enhance the consumable liquid.

### BACKGROUND OF THE INVENTION

In order to enhance the experience or benefit of drinking a consumable liquid, an additive or additives may be added to the consumable liquid. As is disclosed in applicant's U.S. Pat. Nos. 6,705,490 and 6,705, 491, additives may be dispensed from a reservoir in the closure of a consumable liquid container. In these two patents, after an additive from a reservoir in a closure is mixed with a consumable liquid, the consumable liquid is dispensed from the consumable liquid container directly through the closure. Thus there is no need to remove the closure from the container in order to consume the consumable liquid.

Examples of additives which can enhance appeal and value of a consumable liquid are various colorants. Many consumable liquids are clear but would be more marketable if in various colors, which for example are indicative of various flavors. Other examples of additives which can be added to consumable liquids are vitamins and other health related substances. Additives which enhance visuals, taste, flavor and other properties of a consumable liquid may also be dispensed from the reservoir in the closure.

### SUMMARY OF THE INVENTION

A closure with an additive reservoir for use with a container for liquids is comprised of a base including a reservoir for attachment to the container; a plunger that cooperates with the reservoir to release the additive into the liquid, and a spout mounted on the base and moveable to a position allowing the liquid mixed with the additive to be dispensed through the closure without removing the closure from the container.

In a further aspect of the closure, the closure comprises a base member including the chamber for containing the additive and a passageway for allowing a liquid in the container to flow from the container to a consumer. The closure further comprises a plunger in the chamber for causing the additive in the chamber to flow out of the chamber and into the liquid upon being depressed. A spout is movably disposed on the base around the chamber and around the passageway. The spout has a sealing relationship with the passageway when in a first position and a non-sealing relationship with the passageway when in a second position, whereby upon activating the plunger to release the additive into the liquid by moving the plunger from the first to the second position, the liquid, together with the additive can flow through the container opening to the consumer.

In a further aspect of the closure, the base has a collar portion for attachment to the container and a support column for mounting the plunger on the base for movement between the first and second positions.

In a further aspect of the closure, the additive chamber is positioned in the support column of the base with a passageway between the additive chamber and the support column for dispensing the liquid.

In a further aspect of the closure, a stop arrangement is disposed between the plunger in the chamber to block the plunger from sliding out of the chamber both before and after the plunger is depressed.

In a further aspect of the closure, the base, additive chamber, plunger and spout are concentric.

In a further aspect of the closure, the additive is in the form of granules, powder, gel and/or a liquid.

In still a further object of the invention, the closure is in combination with the container.

### BRIEF DESCRIPTION OF THE DRAWINGS

Various other features and attendant advantages of the present invention will be more fully appreciated as the same becomes better understood when considered in conjunction with the accompanying drawings, in which like reference characters designate the same or similar parts throughout the several views, and wherein:

FIG. 1 is a perspective view of a closure containing an additive and being mounted on a container containing a liquid;

FIG. 2 is a perspective view similar to FIG. 1, but illustrating a plunger mounted in the closure and being depressed to release the additive into the liquid;

FIG. 3 is a perspective view similar to FIGS. 1 and 2 but showing the plunger depressed;

FIG. 4 is a perspective view similar to FIGS. 1-3 but showing a spout mounted around a column on the base and lifted to open the closure so that the contents thereof can be dispensed to a consumer;

FIG. 5 is a perspective view similar to FIGS. 1-4 but showing liquid from the container being dispensed through the closure;

FIG. 6 is an exploded view of the closure showing the three parts comprising the closure, as well as an additive in the form a rupturable capsule;

FIG. 7. is an elevation of the closure parts of FIG. 6 assembled;

FIG. 8. is a view similar to FIG. 7, but showing the plunger depressed and additive in the capsule being released from the additive chamber and showing a spout in a first position, preventing liquid in the container to which the closure is attached from passing through the closure;

FIG. 9 is a view similar to FIG. 8 showing the spout moved to a second position allowing liquid to pass through the closure from the container on which the closure is connected;

FIG. 10 is a perspective view of a second embodiment of the invention;

FIG. 11 is a perspective view of a plunger used with the second embodiment of the invention;

FIG. 12 is a perspective view of a third embodiment of the invention wherein a sealing barrier is shown used with an additive capsule;

FIG. 13 is a perspective view showing the operation of the plunger and sealing barrier, and

FIG. 14 is a perspective view of a fourth embodiment of the invention;

FIG. 15 is a perspective vie of a fifth embodiment of the invention prior to releasing the capsule into the liquid, and

FIG. 16 is a perspective view of the fifth embodiment of the invention showing the capsule falling toward a consumable liquid.

### DETAILED DESCRIPTION OF THE PREFERRED EMBODIMENT

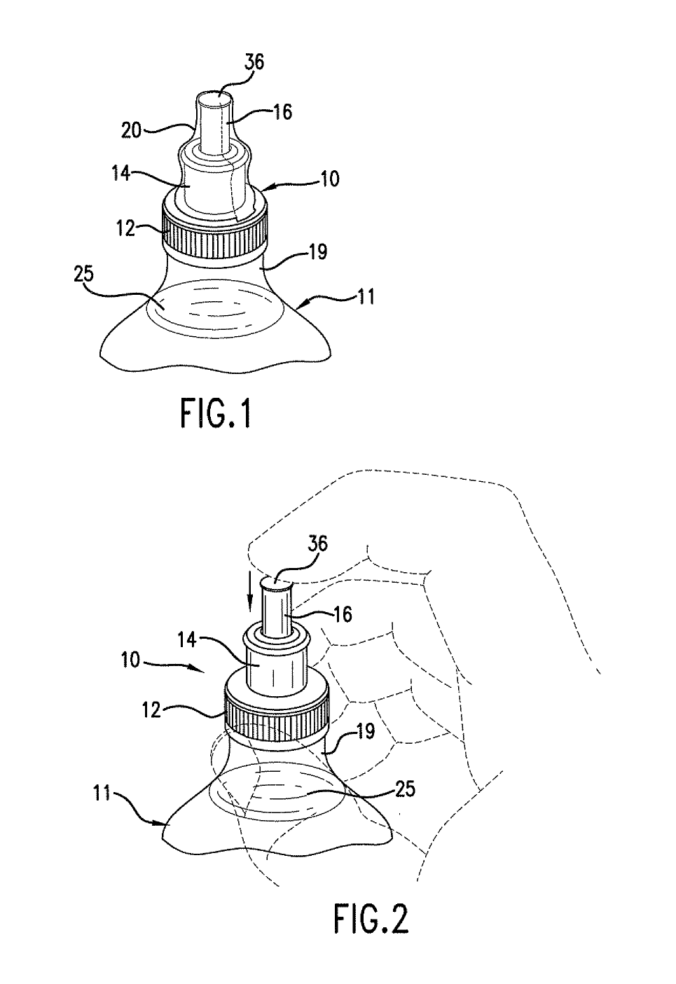

Referring now to FIG. 1, there is shown a closure 10, configured in accordance with the principles of the present invention and mounted on a container 11 containing a consumable Liquid. The consumable liquid may be, but is not limited to, a beverage, a component of a health aide or a medicinal agent. The closure 10 is comprised of a base 12, a spout 14 and a plunger 16 with the base 12 containing an additive and being mounted on the container 11 by a collar 18. The collar 18 may be in the form of a threaded collar that threads with the neck in 19 of the container 11. In order to protect the closure 10 from unauthorized access to the plunger 16, a plastic cap 20 is disposed over the plunger and the plunger is secured to the base 12 with a plastic band. The cap 20 prevents the plunger 16 from being easily depressed by people who are not purchasers.

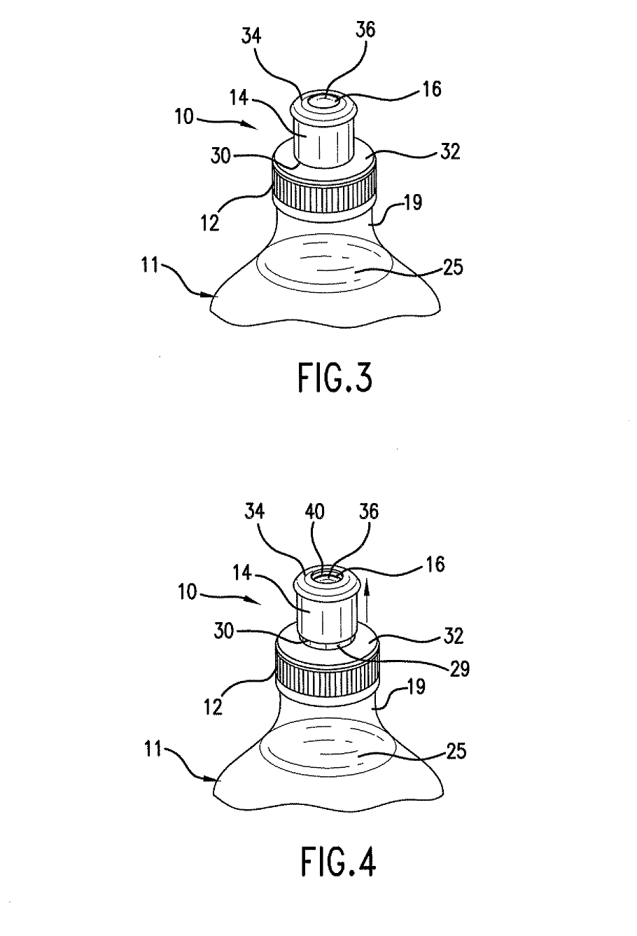

Referring now to FIGS. 2 and 3, the plastic cap 20 is removed from the closure 10 so that plunger 16 and the spout 14 are able to move with respect to the base 12 in order to allow an additive in the base 12 to be released into the container 11. Consequently, the consumable liquid 25 in the container 11 mixes with the additive. As is evident from FIG. 2, this is accomplished by pressing the plunger 16 with a finger, such as a forefinger or thumb to move the plunger toward the container 11 and into the base 12 of the closure 10, as is shown in FIG. 3.

As is further seen in FIG. 3, the spout 14 has a bottom end 30 in engagement with the top surface 32 of the closure 10. A top surface 34 of the spout is flush with a top flange 36 on the now depressed plunger 16. As will be explained hereinafter, the closure 10 is still closed preventing dispensing of the consumable liquid 25 although the additive has been released into the consumable liquid by depressing the plunger 16.

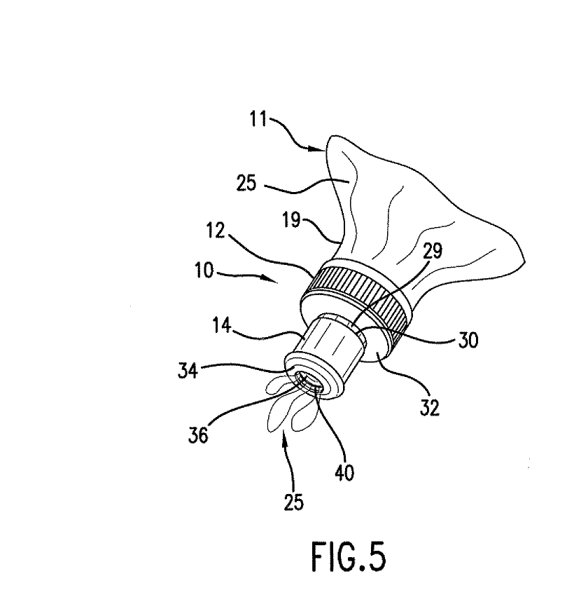

Referring to now to FIGS. 4 and 5, the spout 14 has been moved from a first position to a second position on a column 29 that projects from the base 12, wherein the bottom 30 of the spout is displaced from the top surface 32 of the base 12 instead of being in abutment therewith. As will be explained hereinafter, this opens a passageway 40 between the plunger 16 and the spout 14 to allow the consumable liquid 25 in the container 11, now mixed with the additive from the base 12, to flow through the passageway and out the container when the container is tilted, as is seen in FIG. 5.

The plunger 16 and spout 14 are positioned in proximity to one another so that in moving from the first position of FIG. 3 to the second position of FIG. 4, the plunger 16 may be pushed down or depressed by the thumb of the customer while the spout 14 is gripped between the index and forefinger and pulled away from the top surface 32 of the base 12 to open the passageway 40. When the container 11 is held in the other hand of the consumer the container is easily tilted to drain the liquid 25, now mixed with an additive, into the mouth, cup or glass of the consumer.

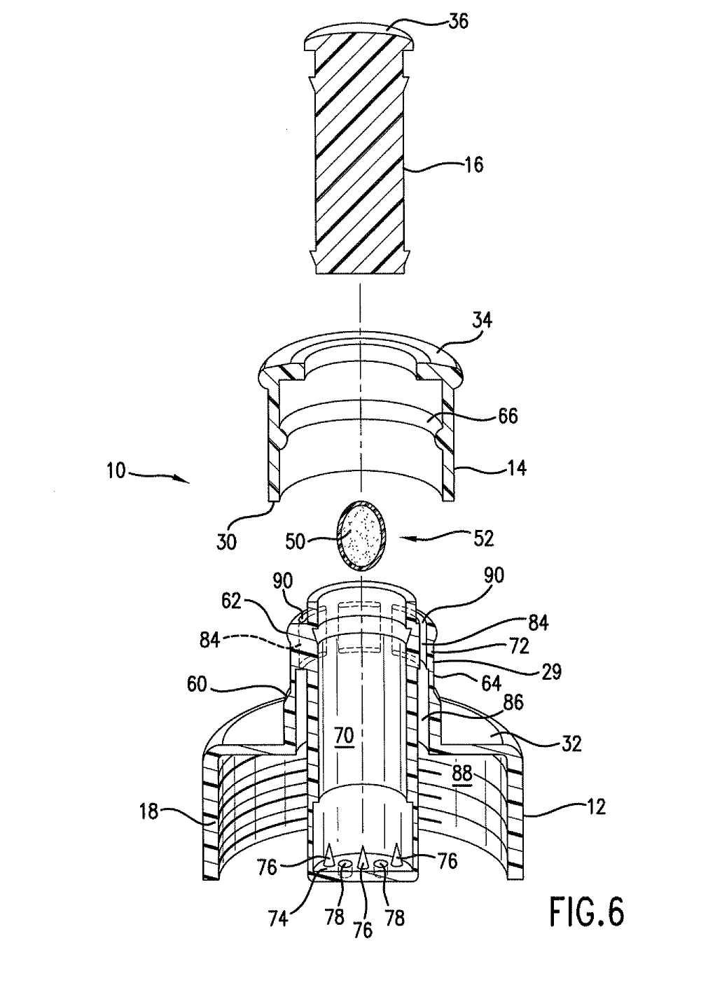

Referring now to FIG. 6, where the closure 10 is shown exploded, it is seen that the closure is comprised of three parts that are readily assembled by a machine. Machine assembly is facilitated when an additive 50 is contained within a capsule 52 having a wall 53 that is rupturable upon depressing the plunger 16. The capsule 52 preferably is made of a fragile gelatin material and preferably has an impermeable coating, such as a hydrophobic coating, which is crushable to release the additive 50. Preferably, the base 12, the collar 14 and the plunger 16 are concentric and made from a plastic material.

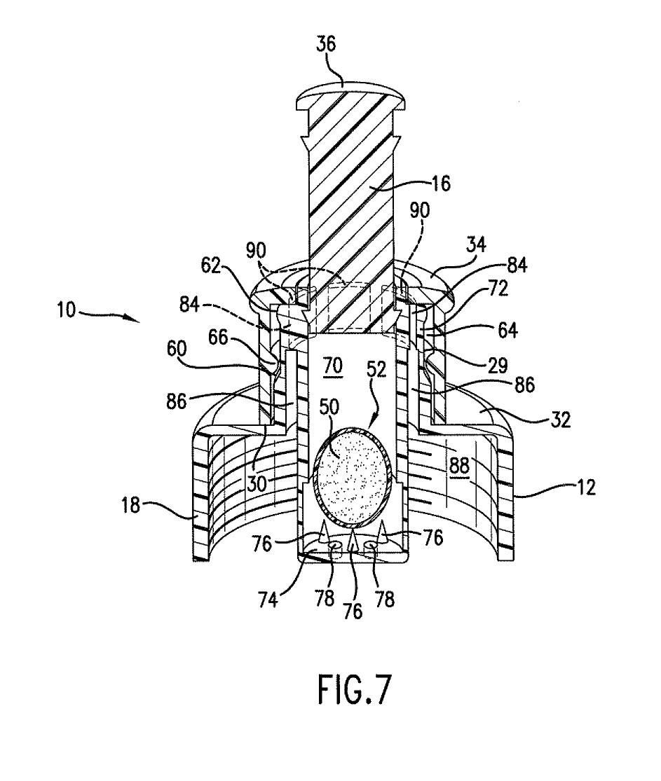

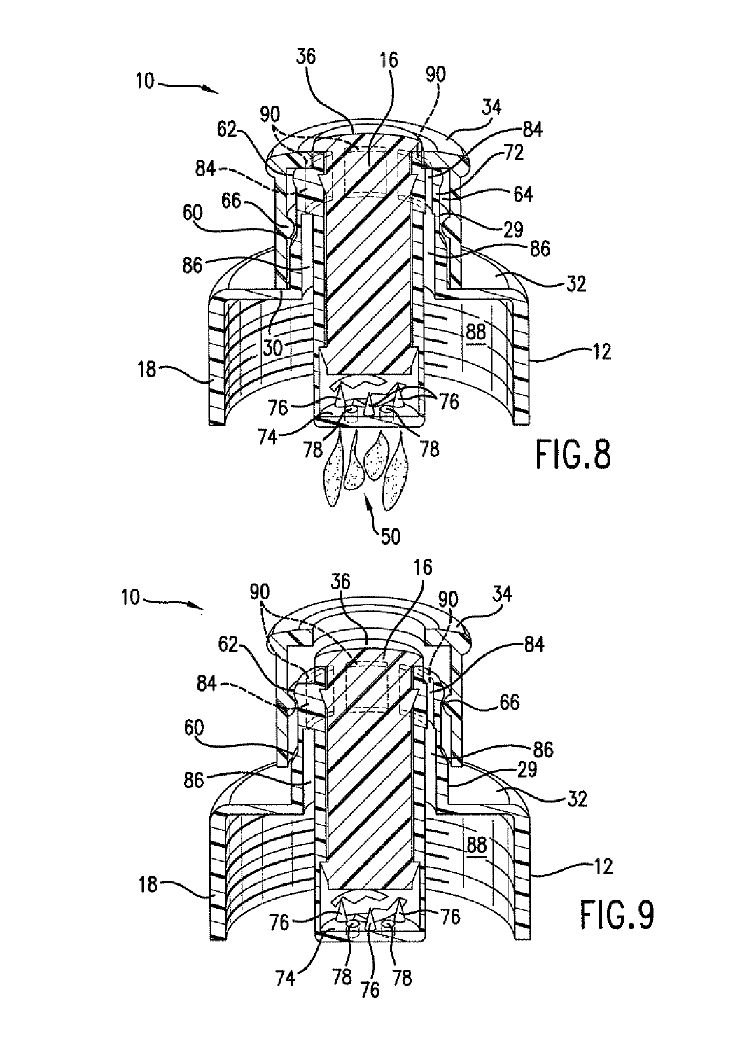

FIGS. 7, 8 and 9 show the components of FIG. 6 assembled with the capsule 52 within the base 12. The collar 18 of the base 12 is preferably threaded for coupling with a threaded neck 19 of the container 11. Other arrangements such as adhesion or crimping may be utilized to accomplish a coupling between the collar 18 and the container 11, or the base 12 may even be integral with the container 11. The support column 29 projects upwardly from the top service 32 of the base 12 to support the spout 14. Around of the support column 29 there are two shoulders 60 and 62 between which there is a gap 64. A circular rib 66, projecting inwardly from the inner surface 68 of the spout 14, is received in the gap 64 to retain the spout 14 on the support column 29. When the spout 14 is in the first position shown in FIGS. 7 and 8 (and FIGS. 1 and 2), the spout 14 is down and in abutment with the annular upper surface 32 of the base 12. When the spout 14 is in the second position shown in FIG. 9 (and FIGS. 4 and 5), the inner annular rib 66 on the spout is in engagement with the outer annular shoulder 62 on the support column 29.

The support column 29 also supports a cylindrical reservoir 70 that has the plunger 16 slidably received therein. The reservoir 70 defines a chamber 71 that contains the capsule 52 and the reservoir 70 is connected to the support column 29 by an annular bridge 72. As is seen in FIG. 8, the floor 74 of the reservoir 70 has at least one conical blade 76 in the form of a punch that punctures or ruptures the capsule 52 to release the additive 50 therefrom into the chamber 72 when the plunger 16 presses against the capsule. The floor 74 has at least one opening 78 through which the released additive 50 drains into the liquid 25. The at least one opening 78 can be a central opening, or any opening allowing the additive 50 to flow into the consumable liquid 25. The opening 78 could also be in the form of peripheral slots 78 disposed in the floor 74 or disposed between the floor and the inner surface of the wall of the cylindrical reservoir 70.

The annular bridge 72 has slots 84 that communicate with an annular channel 86 that opens to a space 88 defined by the collar wall 18 to form the aforementioned passageway 40. Consequently, liquid 25 from the container 11 can flow through the passageway 40 as long as the passageway 40 is not blocked as in FIG. 8 where the top annular flange 34 of the spout 14 covers outlets 90 of the slots 84. Upon shifting the spout 14 from its first position in FIG. 8 to its second position in FIG. 9 where the annular flange 34 on the spout clears the top edge 92 of the support column 29, the passageway 40 becomes unblocked by the annular flange 34, allowing liquid to flow past the support column 29 and thus through the closure 10 to the consumer.

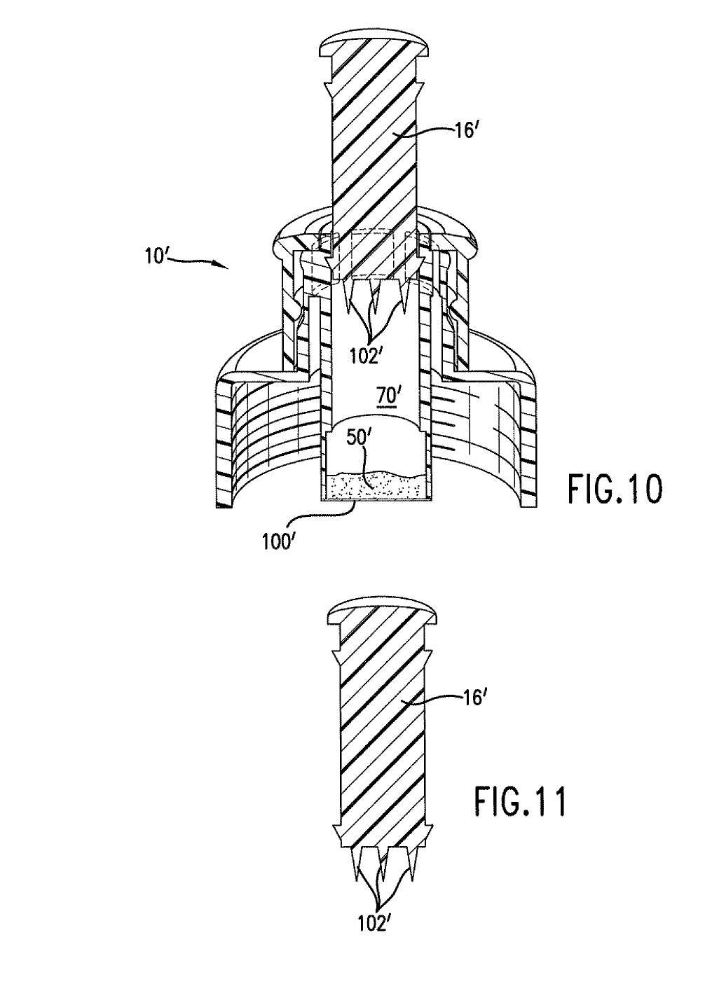

In the second embodiment of the invention shown in FIGS. 10 and 11, the bottom of the reservoir 70′ is covered by foil 100 and the additive 50′ is in the form of a powder, pills or liquid. The plunger 16′ has a projection 102 thereon which punctures or ruptures the foil 100 to allow the additive 50 to drain or fall into the liquid 25 when the plunger is depressed.

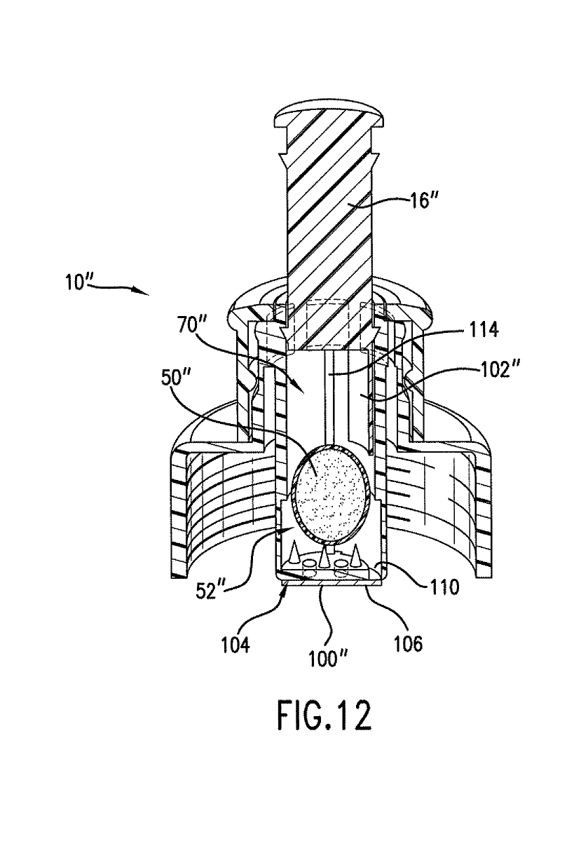

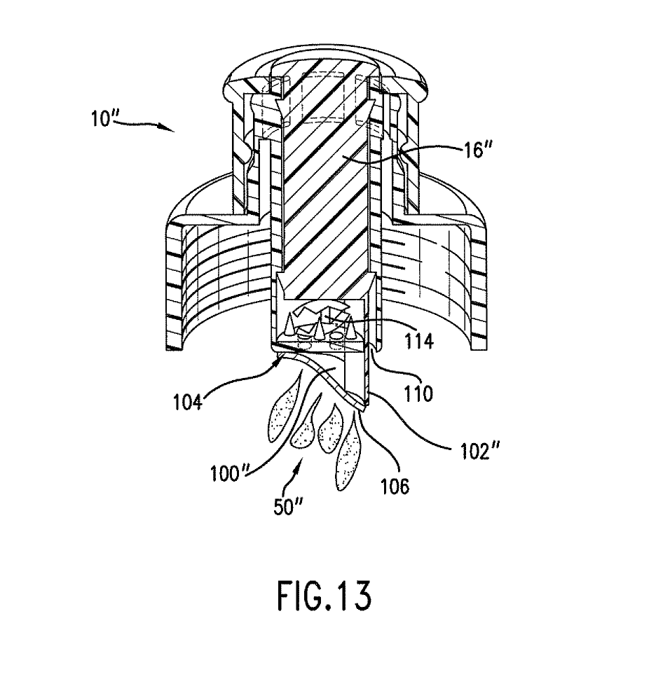

Referring now to the third embodiment of the invention shown in FIGS. 12 and 13, if the wall 53 of the capsule 52 is not hydrophobic and is permeable by the consumable liquid 25, it is necessary to use a barrier such as the barrier 100″ between the capsule 52 and the consumable liquid 25. In the embodiment shown, the barrier 100″ is adhered by heat sealing it very strongly to the floor 74″ at one peripheral location 104 beneath the floor and heat sealing it less strongly along the remainder of its periphery at location 106 beneath the floor. The plunger 16″ has a depending blade 102″ which is arcuate and passes an arcuate slot 110 in the floor 74″ of the reservoir 70″ to engage and dislarge the barrier 100″ along the periphery 106. Thereafter, the capsule 52 is crushed by the plunger 16″ against the punches 76, releasing the additive 50 to flow through the openings 78 through the floor 74″. The barrier 100″ is preferably a metal foil although it can also be made of plastic film. The strong adhesion at location 104 provides a hinge that allows the barrier 100″ to remain attached to the reservoir 70″ and not fall into the container. The plunger 16″ is prevented from rotating by a longitudinal rib 114 on the inner wall of the reservoir 70″, which rib engages a longitudinal groove (not shown) in the plunger.

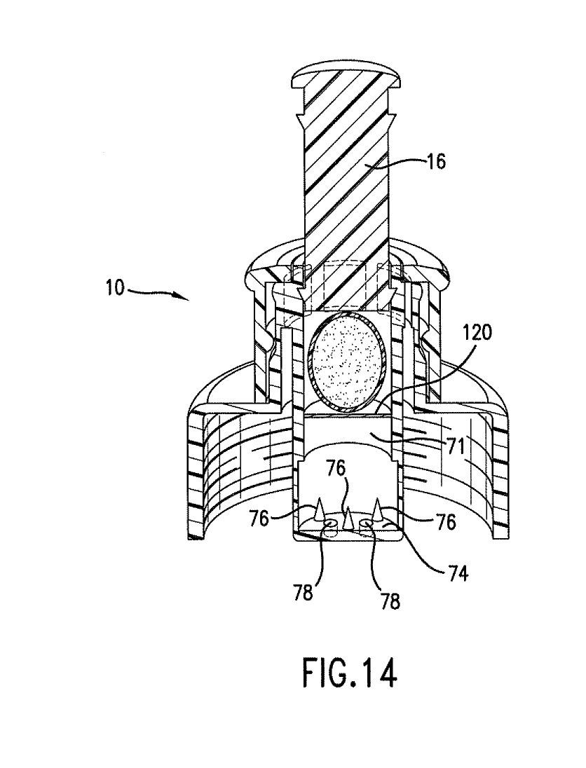

Referring to FIG. 14, a fourth embodiment of the invention, a breakable barrier such as a foil or membrane 120 is heat sealed or otherwise adhered in the cavity 71 in spaced relation to the floor 74. Pressure from the plunger 16 applied through the capsule 52 breaks the foil or membrane 122 allowing the capsule to pass through the foil or membrane and be crushed against punches or blades 76 on the floor 74.

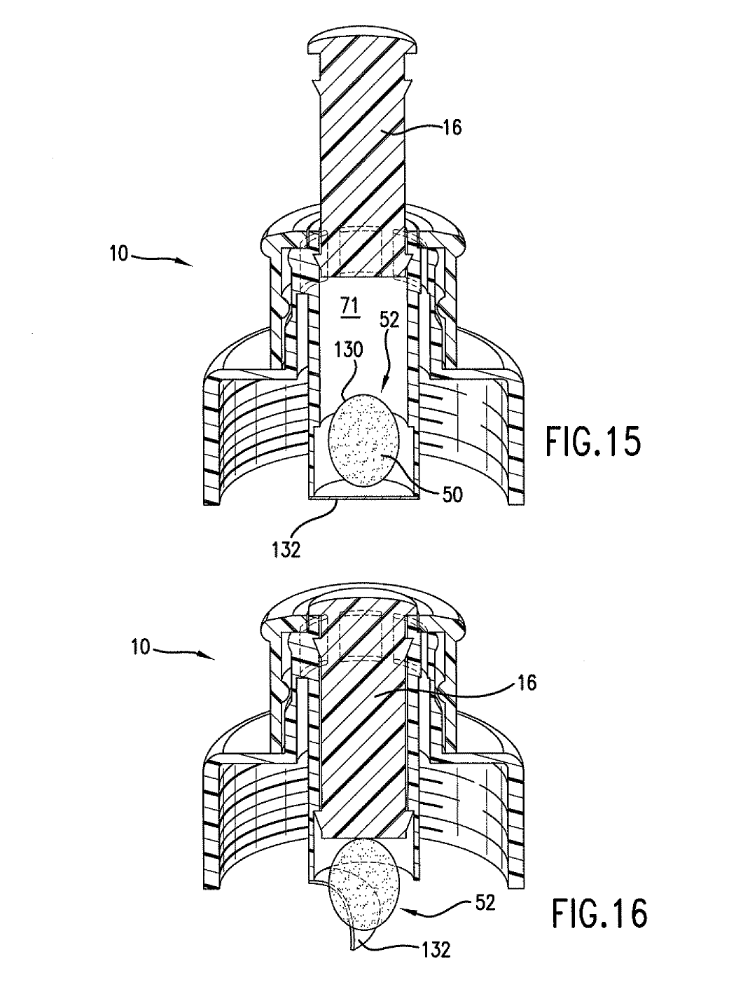

Referring now to FIGS. 15 and 16, in a fifth embodiment of the invention, the capsule 52 has a rapidly dissolvable shell 130 of consumable material which rapidly disintegrates and dissolves upon immersion in the consumable liquid 25 releasing the additive 50. The capsule 52 is initially rigid enough to apply sufficient pressure to a heat sealed foil or membrane 132 to pivot the foil or membrane aside so as to let the capsule pass into the consumable liquid 25 in the container 11.

In all embodiments of the invention, the plunger 16 is prevented from being accidentally dislarged from the reservoir 70 by at least one circular rib 110 on the plunger that registers with first and second circular grooves 112 and 114 in the wall of the reservoir 70. The circular rib 110 is near the bottom of the plunger 16 while the first circular groove 112 is near the top of the reservoir 70 to releasably hold the plunger 16 in the projected position of FIGS. 1, 2, 5, 7 and 11. Preferably the rib 110 has a flat top surface. The second circular groove 114 is near the bottom of the reservoir 70 and registers with the circular rib 110 on the plunger 16 and serves as a stop to hold the plunger retracted in the reservoir while the consumable liquid 25 is being poured or drunk. While one circular rib 110 and two circular grooves 112 and 114 are shown. There may be more ribs and grooves. The ribs and grooves may also be reversed so that the rib or ribs are placed on the reservoir 30 and the grooves on the plunger 16.

From the foregoing description, one skilled in the art can easily ascertain the essential characteristics of this invention, and without departing form the spirit and scope thereof, can make various changes and modifications of the invention to adapt it to various usages and conditions.

We claim:

1. A closure for attachment to a container configured for retaining a consumable liquid therein, the closure comprising:
a base including a chamber for containing an additive and a passageway for allowing a consumable liquid in the container to flow from an opening in the container to the consumer;
a plunger in the chamber for causing the additive in the chamber to flow out of the chamber and into a consumable liquid upon being depressed, and
a spout movably disposed in the base and around the chamber and around the passageway, the spout having a sealed relationship with the passageway when in a first position and an unsealed relationship with the passageway and in a second position, whereby upon actuating the plunger to release the additive into the consumable liquid, and moving the spout from the first to the second position, the consumable liquid together with the additive can flow through the opening in the to the consumer.

2. The closure of claim 1 wherein the base has a collar portion for attachment to the container and a support column for slidably mounting the spout on the base for movement between the first and second positions.

3. The closure of claim 2 wherein the additive chamber is mounted within the support column with the passageway disposed between the additive chamber and the support column.

4. The closure of claim 3 wherein the stop is disposed between the plunger and the chamber to block the plunger from sliding out of the chamber.

5. In the closure of claim 4 wherein the base, additive chamber, plunger and spout are concentric.

6. The closure of claim 5 in combination with an additive.

7. The closure of claim 6 wherein the additive is contained within at least one capsule, which is ruptured upon depressing the plunger.

8. The closure of claim 7 wherein the capsule is impervious with respect to the consumable liquid prior to the capsule being ruptured.

9. The closure of claim 7 wherein the chamber has a floor, the floor having at least one projection for puncturing the capsule upon the capsule being urged thereagainst by the plunger.

10. The closure of claim 5 wherein the additive is retained in the chamber by a membrane or foil sealing to the chamber off with respect to the consumable liquid within the container, the membrane or foil being ruptured or dislarged upon pressing the plunger.

11. The closure of claim 10 wherein the additive is in the form of granules, powder, pills, gel and/or a liquid.

12. The closure of claim 4 wherein the additive chamber projects beyond the support column to provide a sealing surface against which a complementary sealing surface of the spout engages when the spout is in the second position.

13. The closure of claim 6 wherein the additive is a colorant, flavorant or health product.

14. The closure of claim 1 further including a protective cap fitting over the plunger to protect the plunger from unauthorized activation.
